(19) United States
(12) Patent Application Publication
(10) Pub. No.: US 2015/0346777 A1
(43) Pub. Date: Dec. 3, 2015

(54) PROTECTIVE FRAME AND STAND FOR PERSONAL ELECTRONIC DEVICES

(71) Applicant: LENOVO (SINGAPORE) PTE. LTD., Singapore (SG)

(72) Inventors: Satoshi Hosoya, Yokohama-shi (JP); Takehito Yamauchi, Ebina-shi (JP); Masayuki Amano, Yokohama-shi (JP)

(73) Assignee: LENOVO (SINGAPORE) PTE. LTD., Singapore (SG)

(21) Appl. No.: 14/294,697

(22) Filed: Jun. 3, 2014

(51) Int. Cl. G06F 1/16; F16M 11/38

(52) U.S. Cl. CPC G06F 1/1656; F16M 11/38

(57) ABSTRACT

A personal electronic device system may protect a personal electronic device with a frame that may include a movable portion that can provide support as a stand. The movable portion may be pivotally connected to a fixed portion of the frame. The movable portion may be movable from a position planar with the fixed portion to a position angled with the fixed portion.

### BACKGROUND OF THE INVENTION

The present invention generally relates to electronic accessories and, more particularly, to a protective frame and stand for personal electronic devices.

It is known to protect personal electronic devices with a cover to prevent damage to an underlying display. The cover may be slipped over the front and back of the device protecting the entire front face and rear face of the device. Some covers may include a foldable portion that may be folded into a stand. Typically, the foldable portion may set the display at a single angle for viewing.

Typically, a slipped-on-cover may be constructed of fabric and may only be useful in preventing scratching or etching to the device's display. In the event the device is dropped on its edge, the cover may typically be ineffective at preventing shear stress to the edge of the device potentially causing destruction. Any auxiliary protection added to the edge of the device may be too bulky to fit within the aforementioned cover since the cover may be designed to attach directly to the edges of the device.

As can be seen, there is a need for an accessory that may protect a personal electronic device from edge damage and also provide self-standing support.

### SUMMARY OF THE INVENTION

In one aspect of the present invention, a stand for a personal electronic device comprises a frame configured to fit around a perimeter edge of the personal electronic device; and a movable portion of the frame pivotally connected to a fixed portion of the frame, the movable portion movable from a position planar with the fixed portion to a position angled to the fixed portion.

In another aspect of the present invention, a protective device for a personal electronic device comprises a frame including: a front face, and a rear face comprising a solid vertical portion, a solid horizontal portion, a recessed vertical portion, and a recessed horizontal portion; and a stand including a horizontal leg connected to a vertical leg, the horizontal leg pivotal from the recessed horizontal portion, and the vertical leg pivotal from the recessed vertical portion.

In another aspect of the present invention, a personal electronic device system comprises a personal electronic device; a frame configured to fit around a perimeter of the personal electronic device; and a stand integrated into a perimeter of the frame and pivotally connected to the frame.

These and other features, aspects and advantages of the present invention will become better understood with reference to the following drawings, description and claims.

### BRIEF DESCRIPTION OF THE DRAWINGS

FIG. 1 is an overhead perspective view of a personal electronic device system according to an exemplary embodiment of the present invention;

FIG. 1A is an exploded view of the system of FIG. 1;

FIG. 2A is a rear view of the system of FIG. 1 in a portrait orientation;

FIG. 2B is the system of FIG. 2A with a movable portion removed from view;

FIG. 2C is an overhead perspective view of the system of FIG. 2A with the movable portion shown in multiple pivoted positions from the plane of the frame;

FIG. 3A is a rear perspective view of the system of FIG. 1 in a landscape orientation;

FIG. 3B is a side view of the system of FIG. 3A with the movable portion pivoted in an acute angle from the plane of the frame;

FIG. 3C is a side view of the system of FIG. 3A with the movable portion pivoted in a right angle from the plane of the frame;

FIG. 3D is a side view of the system of FIG. 3A with the movable portion pivoted in an obtuse angle from the plane of the frame;

FIG. 4A is a rear perspective view of the system of FIG. 1 in a portrait orientation;

FIG. 4B is a side view of the system of FIG. 4A with the movable portion pivoted in an acute angle from the plane of the frame;

FIG. 4C is a side view of the system of FIG. 4A with the movable portion pivoted in a right angle from the plane of the frame;

FIG. 5A is a side view of an exemplary hinge used in the system of FIG. 1;

FIG. 5B is a perspective end view of the hinge of FIG. 5A;

FIG. 5C is a perspective opposite end view of the hinge of FIG. 5B;

FIG. 6A is a perspective side view of another exemplary hinge used in the system of FIG. 1;

FIG. 6B is an exploded view of the hinge in FIG. 6A;

FIG. 7A is an enlarged view of the upper right circle of FIG. 2A including the hinge of FIG. 5A;

FIG. 7B is an enlarged view of the lower left circle of FIG. 2A including the hinge of FIG. 5A;

FIG. 8A is an enlarged view of the upper right circle of FIG. 2A including the hinge of FIG. 6A; and

FIG. 8B is an enlarged view of the lower left circle of FIG. 6A.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

Exemplary embodiments of the present invention generally provide a frame that protects a personal electronic device and supports the device at multiple angles for viewing.

In the following, use of the terms “horizontal” and “vertical” may be relative to a rectangular frame oriented in a portrait position (for example, with the vertical portions being longer than the horizontal portions).

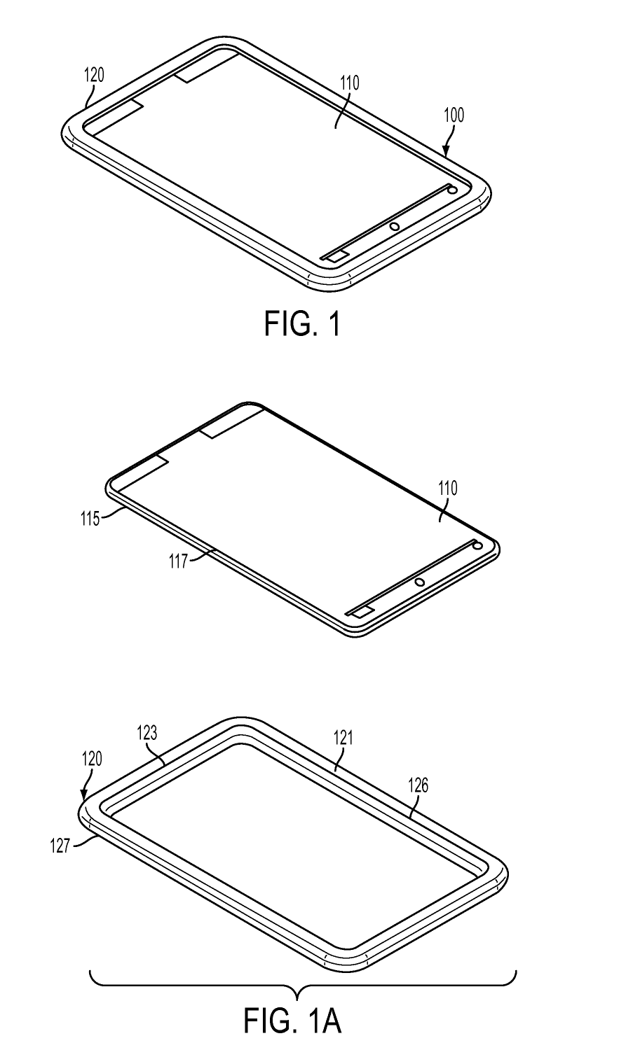

Referring now to FIGS. 1 and 1A, a personal electronic device system 100 (referred to generally as the system 100) is shown according to an exemplary embodiment of the present invention. The system 100 may include a personal electronic device 110 and a frame 120. The personal electronic device 110 may be, for example, a computing tablet or mobile phone. The frame 120 may be configured to fit around a perimeter edge 115 of the personal electronic device 110. For example, the frame 120 may include an internal slot 126 for receipt of the perimeter edge 115.

In an exemplary embodiment, the frame 120 may protect the personal electronic device 110 from shock or damage in the event the personal electronic device 110 is dropped. A front face 121 of the personal electronic device 110 may house a display edge 117 of the personal electronic device 110 and protect the display edge 117 from direct contact with a damaging surface. The frame 120 may include a rigid core 123 (for example, a hard plastic) covered by a shock absorbing exterior 127 (for example, an elastomer). Impact to the perimeter edge 115 may be absorbed by the shock absorbing exterior 127.

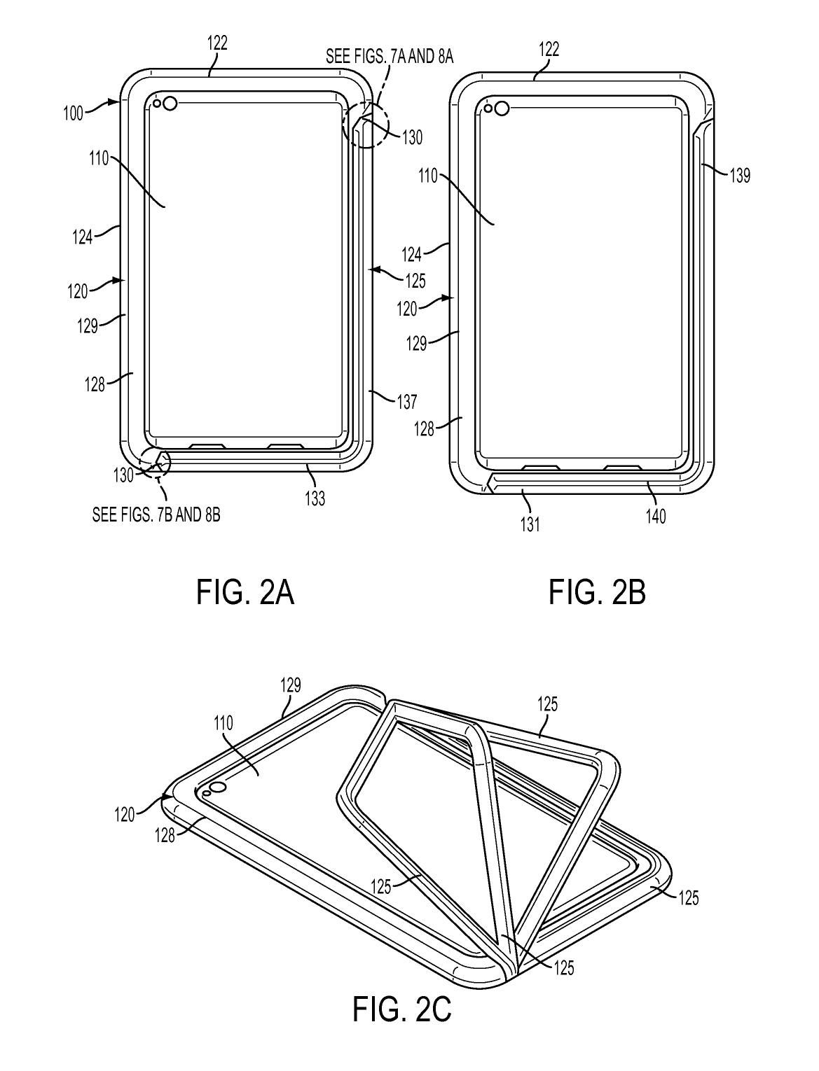

Referring now to FIGS. 2A, 2B, and 2C, a rear face 129 of the frame 120 is shown according to an exemplary embodiment of the present invention. In an exemplary embodiment, the frame 120 may include a movable portion 125 connected to a fixed portion 128 of the rear face 129. The movable portion 125 may be, for example, a stand that may include a horizontal leg 133 and a vertical leg 137. The movable portion 125 may include a rigid core (not shown) and shocking absorbing exterior (not shown) as described above with respect to the frame 120. The movable portion 125 may be integrated into the perimeter of the frame 120 and may pivot therefrom. For example, the movable portion 125 in a collapsed position may abut the fixed portion 128 so that the movable portion 125 may be planar with the fixed portion 128. In a support position, the movable portion 125 may be pivoted from one or more hinges 130 so that the movable portion 125 may be angled from the plane of the fixed portion 128.

In an exemplary embodiment, the frame 120 may be rectangular and the fixed portion 128 may include a solid horizontal portion 122 and a solid vertical portion 124. The frame 120 (on the rear face 129) may also include a recess 140 comprising a horizontal recess 131 and a vertical recess 139. In the collapsed position, the horizontal leg 133 may be nested within the horizontal recess 131 and the vertical leg 137 may be nested within the vertical recess 139. Thus, in the collapsed position, the horizontal leg 133 and the vertical leg 137 may be planar with the solid horizontal portion 122 and the solid vertical portion 124. It may be appreciated that, in the collapsed position, the movable portion 125 (for example, the horizontal leg 133 and the vertical leg 137 as shown in FIGS. 2A and 2C) and the fixed portion 128 cover rear perimeter portions of the personal electronic device 110.

Referring to FIG. 2C, in a support position, the movable portion 125 may be pivoted from the fixed portion 128. In some embodiments, the movable portion 125 may be pivoted from a plane of the frame 120 to an acute angle from said plane and to an obtuse angle from said plane depending on the preference of a user (not shown).

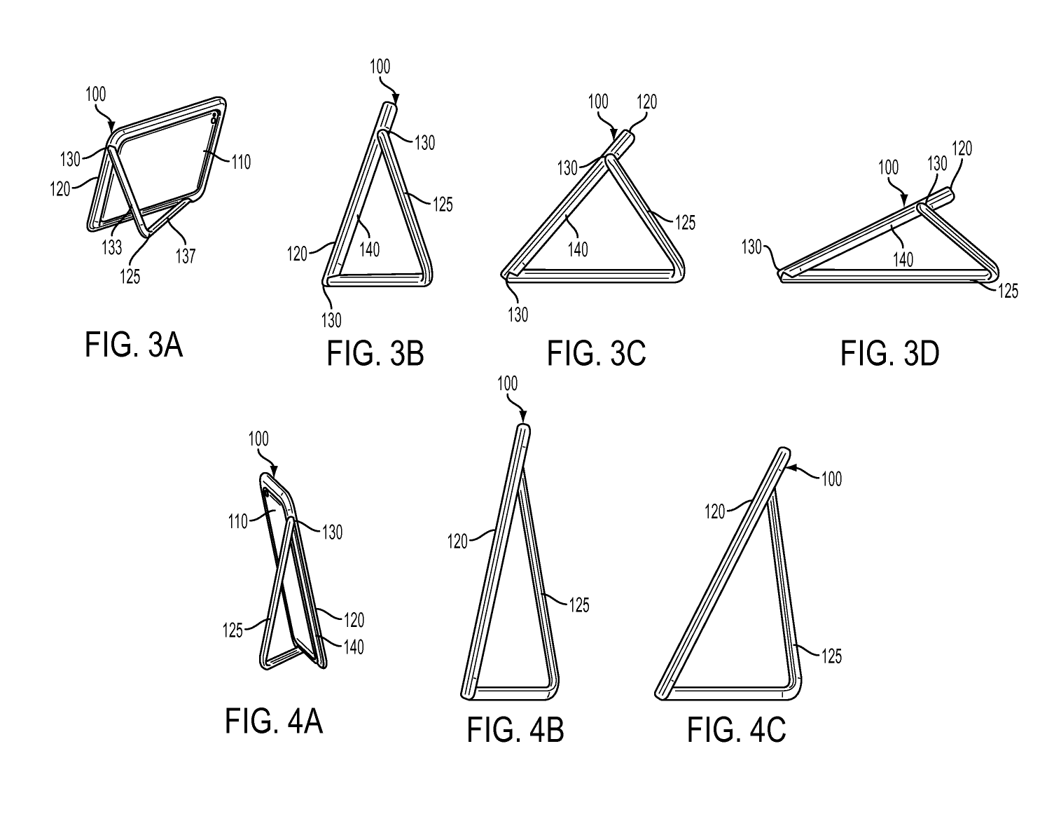

Referring now to FIGS. 3A, 3B, 3C, and 3D, an exemplary embodiment of the system 100 is shown used in landscape mode. It will be understood that the movable portion 125 is supporting the personal electronic device 110 on a support surface (not shown). In some embodiments, the movable portion 125 may be pivoted about the hinge(s) 130 into predetermined angles from the plane of the frame 120. For example, the movable portion 125 positioned at the acute angle (FIGS. 3A and 3B) may be approximately 45 degrees from the plane of the frame 120 so that the personal electronic device 110 displays nearly perpendicular to the support surface (not shown) similar to a user's work station setup (not shown). The movable portion 125 may be positioned at a right angle (FIG. 3C) from the plane of the frame 120 so that the personal electronic device 110 may be tilted upward when one may want to, for example, watch a video. The movable portion 125 may be positioned at the obtuse angle (FIG. 3D) which may be approximately 135 degrees from the plane of the frame 120 positioning the personal electronic device 110 nearly flat from the support surface (not shown) which may be desirable for example when a user (not shown) wishes to play games.

Referring to FIGS. 4A, 4B, and 4C, the system 100 is shown in portrait mode. It may be appreciated that, since the movable portion 125 includes both a horizontal leg 133 and a vertical leg 137, the movable portion 125 may be pivoted similar to the manner shown in FIGS. 3A, 3B, and 3C in portrait mode while the personal electronic device 110 is on a support surface (not shown).

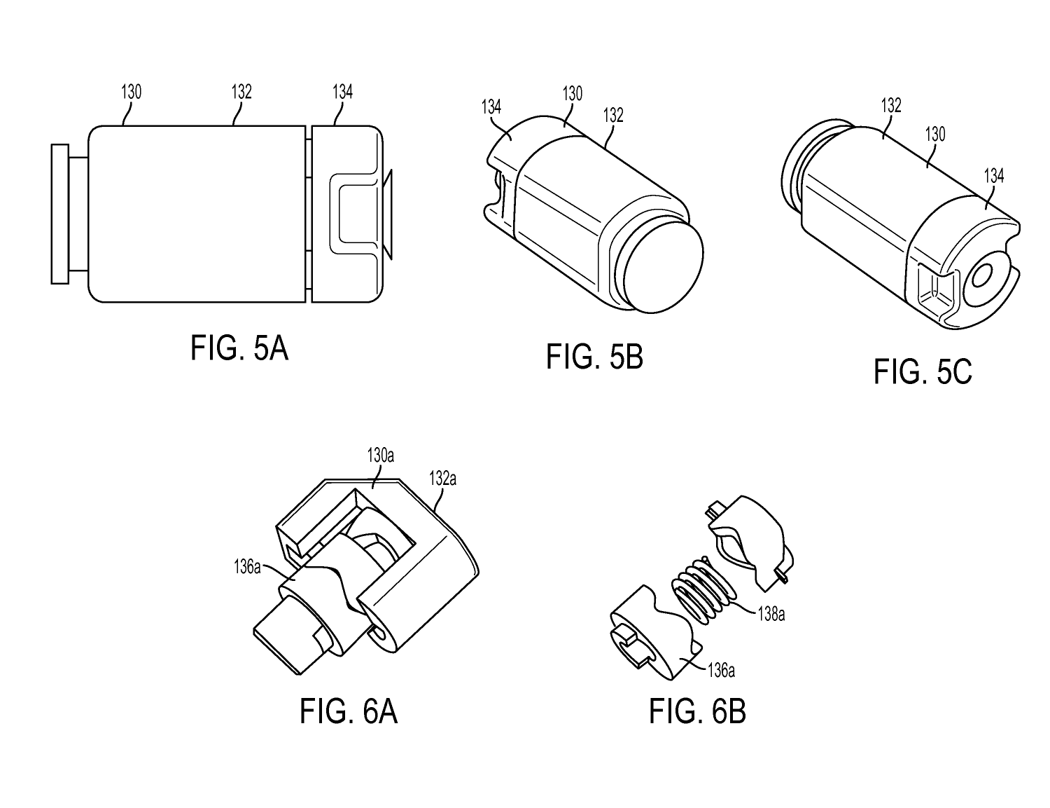

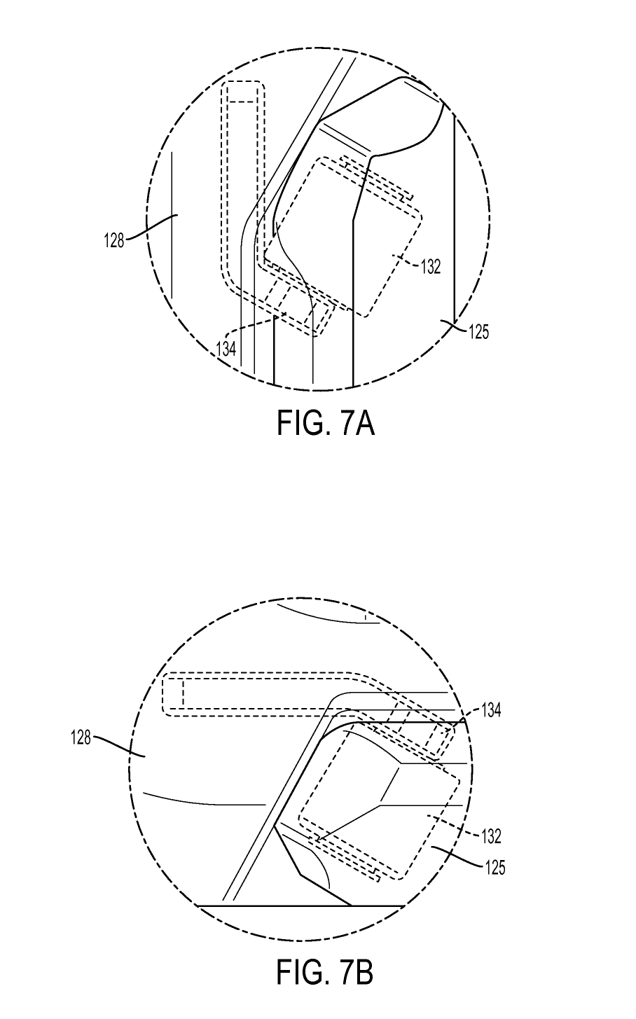

Referring now to FIGS. 5A, 5B, and 5C, an exemplary embodiment of the hinge 130 is shown. The hinge 130 may be a free-stop, torque type hinge. Referring concurrently to FIGS. 7A and 7B, the hinge 130 may include a fixed element 132 and a rotatable element 134. The fixed element 132 may be incorporated within the fixed portion 128. The rotatable element 134 may be incorporated within the movable portion 125. In embodiments using the free-stop, torque type hinge 130, the movable portion 125 may be positioned in an arbitrary angle from the plane of the frame 120.

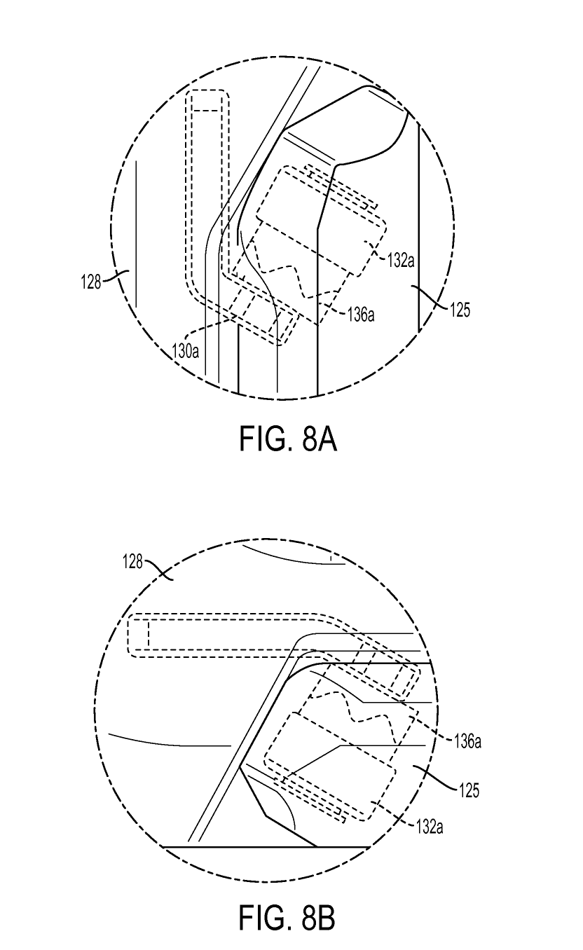

Referring now to FIGS. 6A and 6B, an alternate exemplary embodiment of a hinge 130a is shown. The hinge 130a may be a cam or gear stop type hinge. The hinge 130a may include a fixed element 132a and a cam 136a. A tension spring element 138a may be positioned between the fixed element 132a and the cam 136a. Referring concurrently to FIGS. 8A and 8B, the fixed element 132a may be incorporated within the fixed portion 128. The cam 136a may be incorporated within the movable portion 125. In embodiments, using the cam or gear stop type hinge 130a, the movable portion 125 may be positioned at predetermined angles from the plane of the frame 120 (FIG. 1), for example, as described previously with respect to FIGS. 3A, 3B, 3C, and 3D.

It should be understood, of course, that the foregoing relates to exemplary embodiments of the invention and that modifications may be made without departing from the spirit and scope of the invention as set forth in the following claims.

What is claimed is:

1. A stand for a personal electronic device, comprising:
a frame configured to fit around a perimeter edge of the personal electronic device; and
a movable portion of the frame pivotally connected to a fixed portion of the frame, the movable portion movable from a position planar with the fixed portion to a position angled to the fixed portion.

2. The stand of claim 1, wherein the movable portion, in the position angled to the fixed portion, is configured to support the personal electronic device to stand on a support surface.

3. The stand of claim 1, further comprising a recess in the fixed portion, the recess configured to receive the movable portion in the position planar with the fixed portion.

4. The stand of claim 1, wherein the movable portion is movable from an acute angle from a plane of the fixed portion to an obtuse angle from the plane of the fixed portion.

5. A protective device for a personal electronic device, comprising:
a frame including:
a front face, and
a rear face comprising a solid vertical portion, a solid horizontal portion, a recessed vertical portion, and a recessed horizontal portion; and
a stand including a horizontal leg connected to a vertical leg, the horizontal leg pivotal from the recessed horizontal portion, and the vertical leg pivotal from the recessed vertical portion.

6. The stand of claim 5, wherein the frame is configured to fit around a perimeter of the personal electronic device.

7. The stand of claim 5, wherein the support is movable from an acute angle from a plane of the rear face to an obtuse angle from the plane of the rear face.

8. The stand of claim 7, further comprising a cam stop hinge connecting the horizontal leg of the support to the solid horizontal portion of the frame.

9. The stand of claim 5, wherein the horizontal leg and the vertical leg, in the recessed horizontal and vertical portions, are planar to the solid vertical portion and the solid horizontal portion.

10. The stand of claim 5, wherein the horizontal leg and the vertical leg, in the recessed horizontal and vertical portions, cover perimeter portions of the electronic tablet device.

11. The stand of claim 5, further comprising a free stop torque type hinge connecting the vertical leg of the support to the solid vertical portion of the frame.

12. A personal electronic device system, comprising:
a personal electronic device;
a frame configured to fit around a perimeter of the personal electronic device; and
a stand integrated into a perimeter of the frame and pivotally connected to the frame.

13. The system of claim 12, wherein the stand covers perimeter portions of the personal electronic device.

14. The system of claim 12, further comprising a recess in the frame, the recess configured to receive the stand.

15. The system of claim 12, further comprising a cam stop hinge connecting the stand to the frame.

16. The system of claim 12, further comprising a free stop torque type hinge connecting the stand to the frame.

17. The system of claim 12, wherein the stand is movable from a plane of the frame to an acute angle from said plane and to an obtuse angle from said plane.

18. The system of claim 12, wherein the frame includes a rigid core.

19. The system of claim 18, further comprising an elastomer exterior on the frame.

20. The system of claim 19, wherein the movable portion includes an elastomer exterior.
